(19) United States
(12) Patent Application Publication
(10) Pub. No.: US 2007/0061249 A1
(43) Pub. Date: Mar. 15, 2007

(54) License market, license contracts and method for trading license contracts

(76) Inventor: David Newman, Highland Park, IL (US)

Correspondence Address: David L. Newman, 353 Lambert Tree Avenue, Highland Park, IL, 60035, US

(21) Appl. No.: 11/521,423

(22) Filed: Sep. 14, 2006

Related U.S. Application Data
(60) Provisional application No. 60/717,056, filed on Sep. 14, 2005.

(51) Int. Cl. G06Q 40/00

(52) U.S. Cl. 705/37

(57) ABSTRACT

A license exchange is provided that allows for companies who desire to obtain licenses for intellectual property and speculators to bid in order to set pricing for license contracts that provide for market rates to be set for such licenses. The exchange insures liquidity for such license contracts by providing market makers, scarcity features and predetermined trading periods. In an embodiment the exchange may provide an electronic auction where license contracts may be traded by parties including patentees who may wish to avoid litigation and obtain fair and reasonable royalties for the patents underlying the license contracts being traded.

This application claims the benefit of co-pending provisional patent application No. 60/717,056 filed Sep. 14, 2005.

The present invention pertains to a market for licenses and license contracts to be traded in the license market.

### BACKGROUND

Technology plays an ever-increasing importance in society. However, the ability for third parties to invest in technology, for intellectual property (IP) users to pay fair royalties for use of the technology and IP owners to receive fair compensation for use of their technology remains limited.

An investor today who identifies a specific technology that he or she believes is promising and is worth investing in, is left with only a few choices. If the technology is owned by a public company then the investor may buy stock in that public company. However, the performance of that stock may not be affected solely by that sole technology; as the company may be involved in many different technology areas and the stock performance may be affected by many other factors. If an investor is interested in technology owned by a private company, then the investor must make a direct investment with that private company. Again, the investment in the entire company may be affected by many other factors; as such a company may market other products and technologies, other than the sole technology that the investor is interested in focusing on.

With respect to companies who want to use technology and obtain licenses for technology that is patented by a third party or covered by another's trade secret, the avenues for obtaining proper licenses are limited. Basically the company must negotiate a license with the technology owner. In such circumstances the technology owner generally has the upper-hand as it can refuse to licensor can refuse to set royalty rates that the purchasing party may feel are reasonable. Such an uneven, playing field causes companies to ignore patents or steer away from such license negotiations. In fact, licensing rarely occurs voluntarily by the company making use of the technology. It is more likely that the patent owner or technology owner must confront the company and accuse it of infringement before any license is negotiated. In many circumstances litigation occurs prior to the execution of a license.

Litigation is often an undesirable process and does not always lead to a just outcome for either party. Even where a judge or jury may determine what is a so-called “reasonable royalty,” the parties are rarely satisfied with the outcome. Corporations are being threatened with patent infringement lawsuits at an increasing rate. At such a juncture the corporation has two options: 1) take a license at the rate demanded by the patent owner, or 2) go forward with litigation costing multi-million dollars. Neither of these options are practical or desirable.

Finally, the patent and technology owners who believe that their technology is being exploited by others, without proper compensation, face enormous risks in litigating via patent infringement lawsuits. With the unpredictability of the litigation process and the enormous costs in attorneys' fees reaching nearly $2 million per patent infringement lawsuit; it is only the rare patent that can be asserted. As well, due to the enormous expenses in litigation costs it generally results in the patent owner only being able to pursue a single infringer at a time through litigation. And only if and when that litigation ends successfully with an award or settlement including lump sum payments or on-going royalties, can the patent owner move on to the next infringer.

Therefore, the current marketplace for licensing patents and other technology has many inefficiencies and disadvantages for all parties involved. Therefore, there is desired a new marketplace for patents and other technology which allows for greater distribution of technology and provides a means of establishing reasonable compensation for the technology owners.

### SUMMARY

The present invention concerns an IP license marketplace or exchange which will provide for increased distribution of technology and for the ability to set reasonably rates for such technology. Such a marketplace will allow for third parties to become involved and to invest in particular technologies on a patent-by-patent basis or based on individual patent portfolios. The license market will allow for those who desire to use the technology to hedge their positions while they are developing technology prior to taking a license or during litigation over such technology. The license market will also provide for IP owners a means of obtaining investment early on in order to fund possible litigation and also a means of setting fair royalty rates that are set by market forces.

While the preferred embodiments described herein focus on patents and patent licenses, the license market could work just as well for trade secret technology, trademarks, copyrights, and any other type of intellectual property.

In an embodiment, the exchange takes attributes from many commonly known markets including the stocks derivatives such as options and futures contracts. In an embodiment, the present invention is a patent license contract which is traded on a public exchange electronically or on a trading floor via the open outcry process. The market where such patent license contracts may be traded may be a patent license exchange. In an embodiment, the exchange comprises an exchange platform where license contracts may be traded. The platform may include a system for posting license contract prices, a purchasing feature for providing the purchase of the license contracts, a selling feature for providing the selling of the license contracts and a clearing feature to provide for the execution of the license contracts. The exchange may provide for the electronic trading of the license contracts. The license exchange may provide reports with regard to the underlying intellectual property including patent reports which provide for key valuation criteria.

In an embodiment, a the present invention may provide a license contract comprising a price that correlates to a royalty rate and include preset non-variable license terms including the royalty basis, up front payments and exclusivity and a term of the contract. The license contract may be a futures contract for purchasing the right to obtain a license at a future date. The price of the license contract may fluctuate based on the trading of the license contract.

In an embodiment the license rate bid upon in the auction may be a total rate for a paid-up license under the license contract. In an embodiment, the license rate may be a per unit rate under the license contract. In an embodiment, the exchange platform may allow for companies who wish to obtain licenses and speculators to electronically enter bids using the exchange platform. In an embodiment, the clearing feature may insure that parties who have acquired license contracts will execute the contracts and the underlying license agreements according to the terms of the license contracts. In an embodiment, the exchange platform may provide for license auctions and further includes a liquidity feature for assuring sufficient liquidity so that buyers and sellers will be present during the auction process. In an embodiment, the liquidity feature may comprise at least a market maker, a scarcity feature to control the number of contracts available or a controlled auction period for maximizing the number of transactions that may occur during each auction. In an embodiment, the license contract pertains to intellectual property including a patent.

In another embodiment the invention pertains to a license contract for trading in a marketplace comprising contract terms including a price that correlates to a royalty rate, preset license terms including the royalty basis, up front payments, exclusivity terms and a term of the contract. In an embodiment, the contract may be traded in an exchange in order to set a market price for the price of the contract. In an embodiment, the contract further comprising a futures contract for purchasing the right to obtain a license at a future date. In an embodiment, the price of the license contract may fluctuate based on the trading of the license contract.

In a further embodiment of the invention a method of trading a license contract is provided comprising the steps of providing an exchange platform for entering offers to buy and sell license contracts, entering an offer to sell the license contract at a price that correlates to a royalty rate, entering an offer to purchase the license at the price and executing the license contract and obtaining a license at the royalty rate. In an embodiment, the license contract may pertain to intellectual property including a patent and the contract includes non-variable license terms including the royalty basis, up front payments, exclusivity terms and a term of the contract. In an embodiment, the exchange platform may provide for electronic trading by buyers and sellers using a transparent process so that all trades are posted in real time and providing a uniform price auction. In an embodiment, the license contract may relate to intellectual property and further comprise the step of posting the license contract on the exchange platform prior to using the underlying intellectual property in litigation so that allegedly infringing parties may obtain licenses at rates set by the exchange. In an embodiment, a computer readable medium is provided for establishing a purchasing feature, a selling feature and a clearing feature for handing the offer to purchase, the offer to sell and execution of the contract, respectively. In an embodiment, the method may further comprise the step of paying the license contract owner a premium upon purchase of each contract. In an embodiment, the exchange platform may provide for a single auction on each individual license contract and the method further comprising the step of limiting the number of licenses to be granted for the underlying intellectual property and including in the contract terms an explicit identification of the maximum number of licenses to be granted in a specific field of use in order to insure for purchasers of the license contracts that the price being bid cannot be undercut by parties in another auction separate from the single auction.

### BRIEF DESCRIPTION OF THE DRAWINGS

The drawing discloses an exemplary embodiment exhibiting only various objectives and features of the present invention.

FIG. 1a, b is a flow chart describing an embodiment of the license market system of the present invention; and

FIG. 2 is a system architecture diagram of the license market system of FIG. 1a,b.

### DETAILED DESCRIPTION

As discussed above the present invention may take on features commonly understood with regard to the traditional trading of stocks, options, bonds and/or futures contracts and uses features of well known trading systems such as open outcry trading, electronic trading systems, auctions, etc. As well, the present invention need not only provide a market for the trading of patents or patent licenses, but other types of intellectual property as well. Although the embodiments discussed below focus with respect to patent license contracts the present invention is not to be so limited.

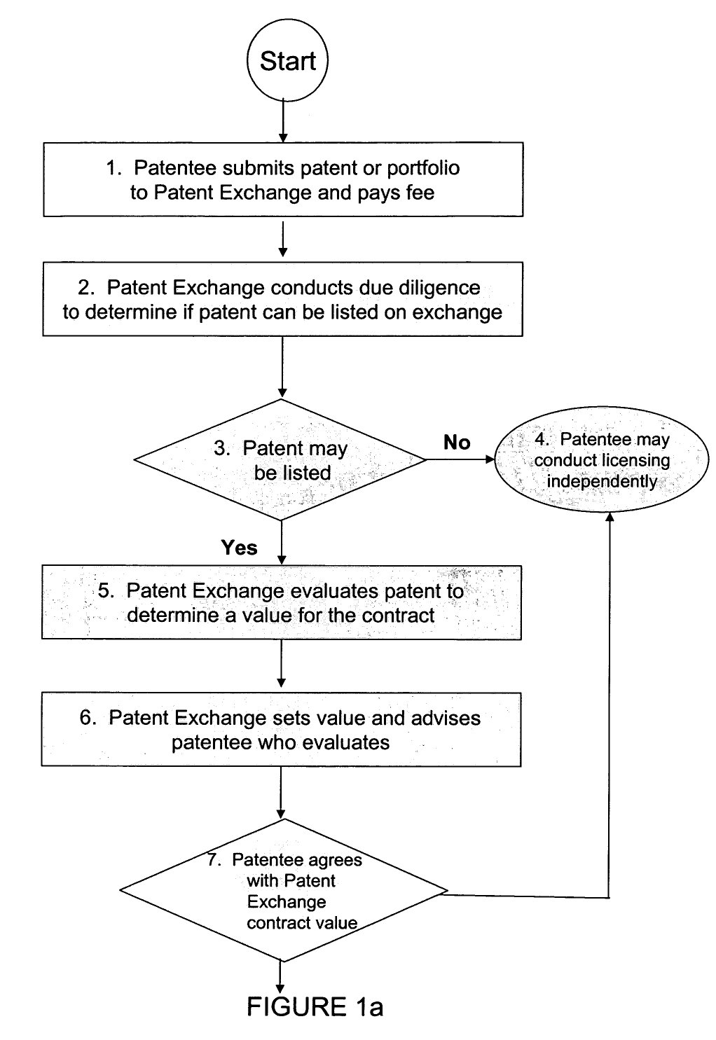

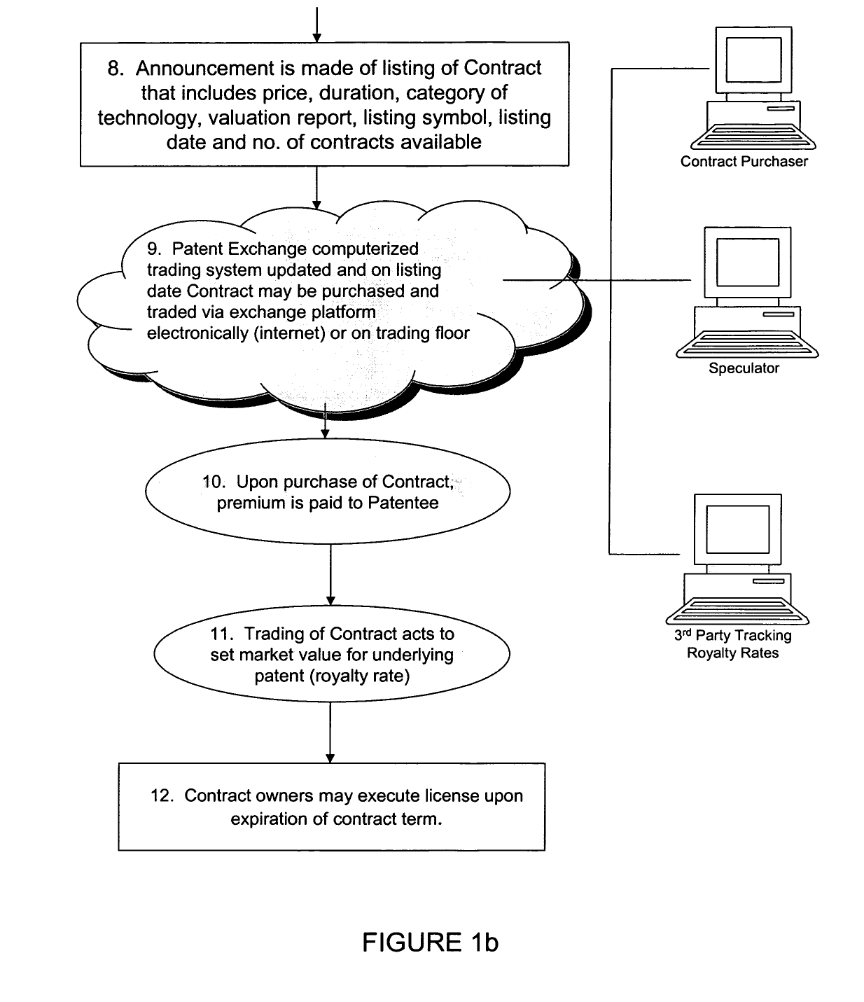

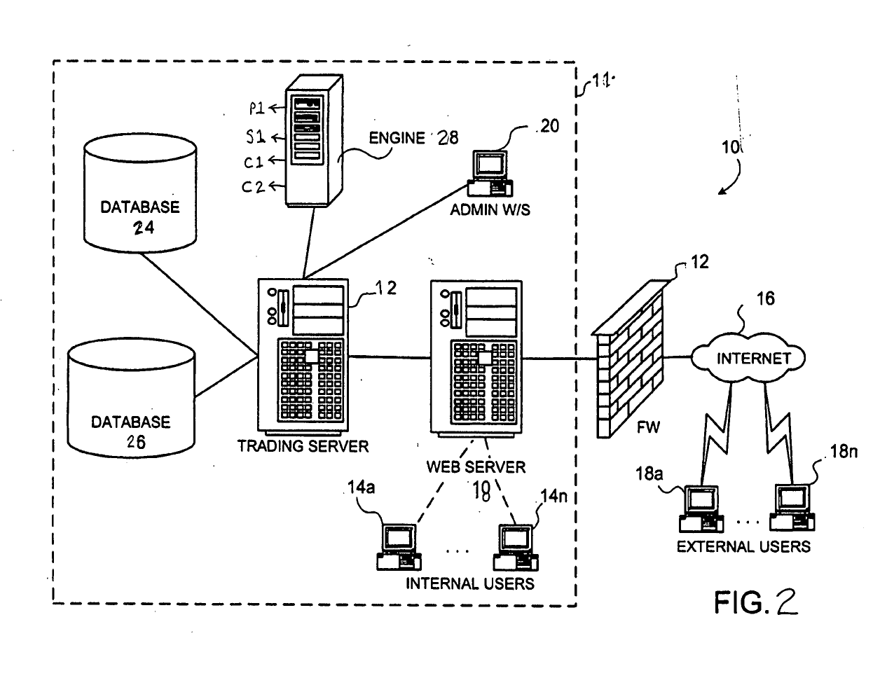

The steps disclosed in FIG. 1 will be discussed in detail and thereafter the architecture that comprises the intellectual property/patent license market or exchange 10 (“exchange”) depicted in FIG. 2. At step no. 1 the patentee submits a patent or patent portfolio to a patent license exchange 10 and pays a fee. The fee that is set may be a standard uniform fee for all applicants who wish to have their patent or patent portfolio listed on the exchange 10. The fee should be set in order to cover the administrative costs of entering the patent into the exchange system 10 and for any underlying valuation that must occur for the patent. In an embodiment, the exchange 10 itself or through the use of third parties such as investment bankers or patent licensing consultants including investment experts, market experts, patent attorneys and licensing experts, will evaluate each patent and arrive at certain valuations. The fee should be set to be high enough so that only serious patent holders may submit their patent to the exchange 10. However, the fee must be lower than the cost of litigation. For example, the fee should likely be less than $1 million, as some patents can be litigated for this price. The underlying benefit of the exchange 10 of the present invention is to provide an alternative to litigation. Overall, the exchange 10 should provide an efficient and reasonable way for patent owners to obtain more licensees for their patents. For example, a fee of between $75,000 to $250,000 should over the cost of the due diligence and provide a gate-keeping future so that only serious patent owners and those who believe strongly in the strength of their patents will apply to have their patents listed on the exchange 10. The patent owner must agree that once it submits its patent to be auctioned on the exchange 10 that it cannot later offer licenses in the same field of use as being offered under the exchange 10.

At step no. 2 a committee of the exchange 10 conduct due diligence to determine if a patent can be listed on the exchange 10. Such due diligence will be conducted by the above discussed group of people including investment bankers, licensing experts, market experts, technology experts and patent attorneys. These experts and the exchange 10 should develop uniform criteria for evaluating patents in order to rate the patents, the claims and the chances for success. Along with the individual analysis of each particular patent and its claims, other means of evaluation may be included as well. For example, there are well-known computerized valuation systems available such as offered by patentratings.com and patentcafe.com, that are incorporated by reference herein. These systems have computerized methods of evaluating patents based on classification, number of words in the claims, technology area, payment of maintenance fees and cross-referencing of the patents either forward or backwards, etc. All this data is analyzed by the exchange committee and a uniform report developed for each patent.

In certain circumstances that exchange committee will determine that the patent is not entitled to be listed on the patent license exchange 10. Such reasons may be that the patent is believed to be invalid, the patent is unenforceable or there is determined to be no market for the license if it were listed (e.g., there are few or no infringers of the underlying patent). The determination that there are few infringers of the underlying patent may be a point of debate for some patents; in that such a determination it would based on an interpretation of the claims and whether particular claims of the patent are infringed. In such instances, groups of patent attorneys may be called on to opine with respect to the scope of the claims of patents in order to determine questions of infringement. While such determinations do not carry the weight of a decision of a federal court; these determinations however, may be a fairly reliable means of fairly determining whether to list the patent on the exchange 10. The exchange committee and its patent attorneys should follow the established rules and patent laws present at the time.

At step 3, the patent owner is provided with the data by the exchange committee such as the underlying patent report. Based on the data the patent owner may decide whether to list its patent on the patent license exchange 10. The patent owner must weigh the benefit of having the patent listed on the exchange 10 which provides for some screening and indication of the strength of the patent. If the patent owner does not agree with the valuation of the patent (including the price set for the contract) there may be procedures set up for the patent owner to submit additional data in order to support a better valuation or higher price, e.g., higher royalty rate. In certain circumstances a patent owner may want the exchange s valuation report to be published, so that it is clear that the public understands that the decision to not list the patent on the exchange 10 was due to the rate set and not for other reasons such as a determination that the patent is not infringed or is invalid. Therefore, a mechanism should be provided by the exchange 10 to allow for the publication of certain information at the patent owner's request.

At step 4, the patent owner may decide not to list his patent on the exchange 10. The patentee of course, still has all of the other legal means available, such as litigation.

At step 5, after the patent is determined to be valid and enforceable by the committee of the exchange 10 and after the patent owner agrees to submit the patent for listing the patent for a one-time only licensing auction, a price may be set by the patent committee. In an alternate embodiment, it may be determined that steps 2-6 should be combined. Otherwise the two separate steps allow for another fee to be paid by the patent owner to the exchange 10.

At step 6 the exchange 10 sets the value and advises the patent owner. The patentee can then determine whether the patent should be listed on the exchange 10, as discussed above. Based on the valuation, the exchange committee will determine which term(s) of the license will be variable and correlated to the license contract price. The committee will then set a value or initial starting price for the contract based on the variables in the contract. For example, in an embodiment, the price may be the variable term of the contract chosen by the committee and or patentee and be set to correlate to a royalty rate. For example, a price set at a $5,000 could correlate to a royalty rate of 5% to be paid when the contract is closed and the underlying license is executed. In other words, the purchaser of the contract obtains the right at the end of the term (e.g., one year) to obtain the license at a 5% royalty based on a set royalty basis explained in the underlying contract (e.g., net sales price of component X of a widget).

If the exchange 10 believes that the submitted patent is listable it will advise the patent owner that it may list the patent on the exchange 10 and the price at which the contract should be listed (e.g., $5,000 per contract). Other terms of the license may also be determined to be variables that will be set during auction on the exchange 10. In most, cases, however, only a single term (e.g. the royalty rate) of the license will be set by the auction process. Patents which the exchange 10 agrees are to be Listed patents are only those which the exchange 10 deems are valid and enforceable and for which there are many potential purchasers of the patent license contracts (in other words, where there are multiple infringers of the underlying patent). After the price has been set, the patent owner may decide not to have his patent listed on the exchange 10. For example, the patent owner may feel that the price set by the committee of the exchange 10 is too low and that it can fair better by pursuing licenses independently through litigation.

At step 7, the patentee who agrees with the valuation may decide not to list the patent on the exchange 10 and may resort to other means such as litigation to enforce its patent. The patent owners who agree with the listing price and would like to have their patent listed on the exchange 10 will execute an agreement with the exchange 10 and proceed to have the patent listed.

The exchange 10 may want to determine if a certain amount of money should be reimbursed to the patent owner who decides not to list their patent on the exchange 10 due to a negative report on the patent. Because some of the investment anticipated by the exchange 10 were the administrative costs to actually list the patent on the exchange 10; these costs will not be incurred if the patent owner has decided not to list such fees might be returned to the patent owner. On the other hand, the exchange 10 also may have a process by which the additional maintenance costs are collected at the time the patent owner decides to list the patent in order to cover the costs of the actual listing.

In step 8, an announcement or posting is made by the exchange 10 of the listing of the patent license contract. The announcement includes the price of the contract, the duration of the contract (e.g., the term), category of technology where the contract will be listed, the listing symbol, the listing (auction) date, the number of contracts available and also the valuation report for the patent will be made available. All of this data is listed in the contract and is made publicly available well in advance of the listing date. In addition, the standard terms of the license underlying the contract are also made available. Most terms will be standardized and non-variable, such as the non-exclusivity of the license, a geographic provision of either in the United States or worldwide, if there are related foreign patents, termination clauses, assignability clauses, auditing provisions and choice of law provisions if the contract is breached. A clause including a termination and penalty for the licensor might be included as well. For example, the termination clause might state that the patent owner agrees that licenses under the patent in a particular field of use shall only be granted during the auction being held by the exchange 10 and that if any licenses are granted after the auction the patent owner grants a royalty free license to the licensee, or that the license may be terminated and the patentee agrees to pay a penalty. One term that may be variable in each contract is the underlying basis for the royalty. Where the patent is based on a specific component that can be easily identified the, license may be based on the net sales price of that component. In other types of technologies, where multiple components provided by an assortment of parts contribute to the underlying technology or patented component, other means of determining the royalty basis may be provided. All of the information concerning the contract may be provided electronically and may be searchable on a website of the exchange 10.

Step 9 is the updating of the exchange computerized trading system 10 in order to provide for the trading of the new contract which is to be listed. At the listing date, the contract goes live and the contract may be traded either electronically or on a floor where individuals can trade contracts via an open outcry system.

The invention may be implemented using conventional general purpose computers programmed according to the teachings of the present invention, as will be apparent to those skilled in the computer art. Appropriate software can be readily prepared by programmers of ordinary skill in the art based on the teachings of the present disclosure.

An appropriate computer system may include a bus or other communication mechanism for communicating information and a processor coupled with bus for processing the information. The computer system may include a main memory, such as a random access memory (RAM) or other dynamic storage device, coupled to bus for storing information and instructions to be executed by processor. The computer system may include a read only memory (ROM) or other static storage device coupled to the bus for storing static information and instructions for processor. A storage device, such as a magnetic disk or optical disk may be provided and coupled to the bus.

The computer system may be coupled via bus to a display, for displaying information to a computer user such as a company bidding for a license contract. The mapping of inputs may reside on a computer-readable medium. The term a “computer-readable medium” as used herein refers to any medium or media that participate in providing instructions to processor for execution. Such a medium may take many forms, including but not limited to, volatile media, non-volatile media, and transmission media. Volatile media includes dynamic memory, such as main memory. Non-volatile media includes, for example, optical or magnetic disks, such as storage device. Transmission media includes coaxial cables, copper wire and fiber optics, including the wires that comprise bus. Transmission media can also take the form of acoustic or light waves, such as those generated during radio wave and infrared data communications.

Common forms of computer-readable media include, for example, a floppy disk, a hard disk, flexible disk, magnetic tape, or any other magnetic medium, a CD, CD-ROM, any other optical medium, punch cards, a RAM, a PROM, a FLASH-EPROM, and EPROM, any other memory chip or cartridge, a carrier wave, or any other medium from which a computer can read.

Varying forms of computer readable media may be involved in carrying sequences of one or more instructions to the processor for execution. The computer system may include a communication interface coupled to bus. The communication interface provides a two-way data communication coupling to a network such as any packet switched local area network (LAN) or an asymmetrical digital subscriber line (ADSL) card, an integrated services digital network (ISDN) card or a modem to provide a data communication connection to a telephone line.

The network typically provides data communication through one or more networks to other data devices such as through an IP (Internet Protocol) network (e.g., the Internet or an Intranet) that transmit notifications and receive data, including program code, through the network(s).

In an embodiment, the trading system 10 includes an exchange platform 11 including a trading server 12 that serves as the “back-end” (i.e., IP processing system) of the present invention. Connected to trading server is a database 24 and an IP prior art database 26. The trading server 12 is connected to a Web server 18 which sends out web pages in response to Hypertext Transfer Protocol (HTTP) or Hypertext Transfer Protocol, Secured (HTTPS) requests from remote browsers. The web server provides a “front end” for the exchange system 10 via graphical user interface (GUI) to users of trading system 10 in the form of Web pages that have for example, license contract trading information including lists of pending contracts and currently bid prices via a plurality of workstations 14a-14n, 18a-18n and administrative workstation 20. Included in the back end is a trading engine 28 that supports a purchasing feature P1 for providing the purchase of license contracts; a selling feature S1 for providing the selling of license contracts; a clearing feature C1 for providing the execution of license contracts; and a correlation feature C2 to indicate how the price bid for the contract correlates with the variable term of the underlying license, such as the royalty rate.

The Internet 16 of the outside of the LAN may include a plurality of external workstations 18a-18n that allow traders, bidders, speculators and market watchers to remotely access and use the exchange 10. The system may be run in a distributed fashion over a plurality of network elements connected via the LAN. Databases physically located on one or more computers may or may not be in the same as servers. Communication between parties using the exchange system may be accomplished through any suitable communication means, such as a telephone network, Internet, Intranet, point of sale device, personal digital assistant, cellular phone, kiosk, online communications, wireless communications, off-line communications, transponder communications, etc. For security reasons, any databases, systems, or components of the present invention may consist of any combination of databases or components at a single location or at multiple locations. Each database or system may include any of various suitable security features, such as firewalls 12, access codes, encryption, decryption, compression, decompression, and/or the like. Some or all of the aforementioned components make up the exchange trading platform 11 of the present invention.

At step 10, a premium is paid to the patent owner upon the purchase of each contract. For example, when a price of $5,000 is set for a contract, it is paid directly to the patent owner. This is a means of raising funds for the patent owner and provides incentive for the patent owner to list his patent on the exchange 10. Payment of the premium can be a means of raising funds for the patent owner even if the contract is not closed out (i.e., if the underlying license for the contract is never executed). In an alternate embodiment, the price of the contract may have no relationship to the premium paid to the patent owner and there may be a flat premium set which is paid to each and every patent owner for the underlying contract, regardless of the price that is set for the contract. For example, a standard premium of $25,000 may be set for each contract that the purchaser of the contract must pay. A portion of that premium may go to the patent owner, another portion of the premium may go to the exchange 10 in order to cover expenses for the exchange 10. As well, some of the premium may also be paid to the traders of the contracts such as a market maker or other brokers involved in the trading.

At step 11, trading of the patent license contracts occurs during the term of each contract and such trading acts to set a market price for the patent license contract. Third parties and the contract owner may trade the contract at any desired price (above the contract owners reserve price). For example, if the underlying patent for the contract relates to technology which helps to refine petroleum more quickly and during the contract term the prices for barrels of oil rises dramatically; the value of the perceived technology will be deemed to have been increased. Thus, the price of the contract would likely also rise. On the other hand, if during the term a new technology is introduced which is being used by refineries, other than the patented technology underlying the contract, the contract price is likely to go down. As well, if during the term a favorable decision is issued in related litigation which strengthens the patent, the contract may be deemed to be more valuable and the price for purchasing that contract would likely go up.

The exchange 10 must carefully set the number of contracts to be listed in order to provide for liquidity of these contracts. In some cases where there may be only hundreds of potential licensees who would purchase these contracts, the number of contracts listed for the underlying patent will be very limited. For example, if the exchange 10 determines that there are currently 900 potential infringers of the underlying patent, it may only issue 500 contracts; in order to provide for liquidity and a robust market for trading contracts. In other circumstances, the exchange 10 may provide liquidity by acting as a purchaser or buyer of the contracts itself, to be sure that there is always a purchaser and buyer for all the contracts being listed.

In another embodiment, a market maker will be present for each auction to allow for speculation to occur on the sale price or rate for each contract. For example, Company A (who desires to obtain a license to the patent underlying the contract) bids $50,000 for license contract “W100” (for the Widget technology correlating to a royalty rate to be paid under the executed contract of 5.0%). Speculator 1, who believes the contract price is too low and that at a later time in the auction other companies will pay a higher price offers to buy Company A's W100 contract (and possibly contracts of other companies) for $51,000 (representing a royalty rate to be paid under the executed contract of 5.1%). While this offer by Speculator 1 occurs, the exchange 10 allows for the other 499 contracts to be traded which will act to set a trading price for the W100 contract. In such a situation, the market maker for the W100 auction may see that the W100 contracts are likely to climb higher may purchase 10 contracts at $51,000 each. Sensing that higher pricing might continue, ten companies who need licenses may then enter the auction and purchase the contracts at $52,000 each from the market maker. Such a transaction would net the market maker $10,000 and result in the ten purchasing companies obtaining the right to execute the license contracts at a later date (for example, 3 months) and obtain a license at a royalty rate of 5.2% of the net sales price of widgets sold by the companies (or according to the other pre-established terms listed in the W100 contract).

Meanwhile, having seen the purchase price of $52,000 of the market makers contracts via the transparent trading system 11 of the exchange 10, Company A might turn down Speculator 1's $51,000 offer. Because Company A feels that since it was able to get a license contract at a low rate, it will provide a competitive advantage to Company A to manufacture Widgets and pay only a 5.1% royalty—while its competitors pay a higher 5.2% royalty. In an embodiment, the actual names of the bidding companies is not disclosed via the exchange trading system 10 during the auction and Company A can only speculate who it competitors are who paid a higher price for the license contracts. In an alternate embodiment, the exchange 10 may allow for a completely transparent bidding process where the name of the company or speculator making each bid must be disclosed.

As trading continues, companies and speculators will monitor market data that may affect the value of the license obtainable under the W100 license contract during the trading period (which may last from many hours to many days depending on the number of contracts being offered) for the companies that may need a license (because they may be currently infringing the underlying patent of the W100 contract or may want to enter the Widget market). In view of the above example, it can be understood that use of liquidity features such as facilitating the bidding by speculators, allowing market makers to control and participate in the trading, providing a scarcity feature for controlling the number of contracts available and the time period for the auction; a sufficiently liquid market can be established that can set market rates for patent license contracts, even though the total number of contracts may be only in the hundreds and each underlying patent is unique. Such a system might be used to establish a hypothetical durable goods monopoly for the goods or services underlying the license contract so that purchasers of such contracts are insured of the relatively limited license grants that will occur.

Further, different types of auctions including reverse auctions, Dutch auctions, Vickrey auctions, etc. can be used to motivate different parties to buy and sell the license contracts and to affect the pricing of the contracts. For example, a type of uniform price auction could be used where the 100^{th} (or some other preset number) bid will be the bid price that sets a uniform price for all those obtaining a license contract (e.g. if the 100^{th} bidder purchased a contract at $52,000 that correlated to a 5.2% royalty rate all other contracts would be set at 5.2%). In an alternate embodiment, the last twenty five parties bidding on the contracts would set the variable component of the contract (e.g. the royalty rate or some other term). If such auction systems were used, integrity procedures must be put in place to be sure that the trigger point for setting the uniform variable rate (e.g. bid price correlated to a royalty rate) could not be manipulated by the bidders and that each bidder for the contracts would be committed to actually making, using, selling or importing the goods or services underlying the contract—so that they could not merely execute the license agreement and never pay a royalty.

Thus, it can be understood that during the term of the contract, much trading of the contract may occur between many parties and many events may occur which will change the price of the contract. It is also to be understood that hundreds of contracts on different patents are to be traded simultaneously establishing a wide ranging, dynamic, technology marketplace.

As well, during a contract term the average pricing during that period could provide for very useful information for many other purposes. For example, other contracts on patents dealing with similar technology could be analyzed in order to set those prices when such contracts are being listed. As well, the pricing range for the contracts may also provide for a basis for determining reasonable royalties of the patents or related patents in litigation or in negotiation between parties for related licenses. Investment bankers could use the information to value stocks in companies with technology similar to such patent license contracts. Therefore, it is understood that the market forces involved in setting the pricing of these contracts can provide extremely valuable data that could be used across entire industries for determining valuation of technology.

At step 12 the patent license contract may either be executed by the owner of the contract at the end of the term, or it may be allowed to expire without the patent owner executing the license. For example, a corporation who is involved in litigation with the patent owner who is facing an on-going lawsuit and much cost and expense for that lawsuit and has purchased a patent license contract for the litigated patent, may decide at the end of that term that it would be better to execute the license underlying the contract rather than continue with the litigation. However, if the price at which the corporation had purchased the contract is much higher than the current market price of the contract and there are additional contracts being listed for that patent; then the owner of that contract may decide to simply let it expire without executing it hoping that it can obtain a patent license contract at a lower rate at a future date. Thus, it can be understood that this exchange system provides an option for corporations who are being sued or offered licenses to obtain a patent license at a rate at which the market has had some input in setting the rate. This is likely to be viewed much more favorably by CEOs rather than having to take the license at a price that is demanded by the patent owner.

Other types of pricing mechanisms for the contracts may be undertaken as well. For example, the price need not be correlated to the royalty rate of the contract. The price may be correlated to a lump sump license fee or may be correlated to an overall value of the patent (e.g., the total amount of royalties assumed to be taken in under the patent for a specified period). As well, the pricing of the contract should be correlated in order to encourage the maximum amount of liquidity for these contracts. Such pricing should encourage those who want to use the technology to purchase the contracts and to hold on to the contracts and execute them when the market forces have indicated that the underlying technology is as valuable or more valuable than the price set for the contract. The pricing should also take into account the proper compensation due to a patent owner who is licensing its technology. Pricing of the contracts in order to take into account such requirements by a patentee and licensee can be determined using known valuation techniques such as described in U.S. patent application no. 2001/0042034, incorporated herein by reference.

In an alternate embodiment of the system, the contract may require the purchaser to execute the license at expiration or face a significant buyout penalty. By listing his patent(s) on the exchange 10, a patent owner is giving up his right to exclude others from the market. For example, in a case where a patent owner has undertaken an infringement lawsuit against an infringing the company A; the patent owner generally has the right to pursue an injunction against company A in order to prohibit company A from using the underlying technology. However, if the patent owner has listed his patent on the exchange 10, company A during the litigation may in turn purchase a contract which gives company A the right to have a license. Therefore the threat of injunction via the lawsuit is no longer driving company A to take a license. This is a powerful motivation that the patent owner is giving up by listing his patent on the exchange 10. Therefore, some buyout of the contract or penalty when it is not executed may provide some incentive to the patent owner to list and give up his right of injunction against patent infringers.

In an embodiment, the exchange 10 may keep the names of the purchasers of contracts confidential so that the underlying patent owners are not aware of which parties can execute the contracts. This will allow the company purchasing the patent to maintain its position during a license negotiation that the patent is not being infringed despite the fact it has purchased a contract.

In a further alternate embodiment, each contract may only purchase a portion of an underlying license and multiple contracts may be needed to be purchased in order to obtain the entire license. This will help to produce more liquidity in the market. In another embodiment, each contract may be a portion of the royalty rate and may also correlate to a lower royalty rate based on the additional number of contracts that are purchased.

In an alternate embodiment, premiums may be directed to the purchaser to encourage them to sell when the price has gone up. For example, if a contract is priced at $5,000 and the owner of the patent executes the underlying license at a 5% royalty rate; that contract owner is unlikely to sell the contract for $6,000 (e.g., a $1,000 gain per contract), when that underlying patent owner might lose millions of dollars for that 1% rate in the underlying license. Therefore, additional incentive might be provided to be paid to the contract owner in order to encourage them to sell when the price of the contract rises.

In an alternate embodiment, the contract price may be based on a multiple of a contract price (e.g., each $100 is worth $1,000,000 in value of the license). For example, a contract having a price of $1,000 may provide $10,000,000 in license coverage (e.g., $10,000,000 worth of royalty payments).

In a further embodiment of the invention, a whole corollary exchange may be set up to trade options based on the underlying contracts. In other words, an option may be available based on the underlying contract in order to hedge the positions of the contract owners. The option may be a put if the option owner believes that the underlying contract price will go up or maybe a call if the option owner believes that the underlying contract price will go down. In this way a patent license options exchange may be established in order for third parties to hedge their positions on certain technology, whether they are owners of the underlying patent license contract owner or just a third party speculating on the market. The license option market may be set up based on other underlying contracts or securities tied to patents or patent portfolios as well.

In an alternate embodiment, the pricing of the contracts may be arranged in a way to provide for an inverse relationship between the royalty rate and the price paid for the contract e.g., as the price of the contract increases the royalty rate will decrease. For example, the following pricing schedule may be provided.

| | |
|---|---|
| 1% = | $10,000 |
| 2% = | $9,000 |
| 3% = | $8,000 |
| 4% = | $7,000 |
| 5% = | $6,000 |
| 6% = | $5,000 |
| 7% = | $4,000 |
| 8% = | $3,000 |
| 9% = | $2,000 |
| 10% = | $1,000 |

Thus as can be seen in the above pricing example, the contract purchaser will pay more for a contract having a lower royalty rate.

In an alternate embodiment a patent investment trust may be set that sets its price based on the royalty income that's brought in under the patent. The price of the patent investment trust stock will go up and down based on the amount of royalty income.

In all of the above embodiments, the trading of the contracts can be implemented either on an actual trading floor or electronically. The electronic trading of the contracts can occur through the Internet by a Web site or by a private electronic distribution system. For the above market to operate, it would be preferable to require that the patent owners make certain information available. For example, if the underlying patent to the contract has current licensees, the patent owner should be obligated to disclose the royalty revenue obtained under licenses for that patent. This data will help purchasers of the contracts to more accurately set the pricing and pay the proper amount for each contract in view of the current licensing data.

A benefit of the above system is that although during certain periods only a limited number of contracts to obtain licenses will be available; however, after each contract period additional licenses could be available so that the patent owner is not restricted in the amount of licenses it may offer and have executed.

The above examples are based on a one-to-one evaluation pricing method where each contract is priced based on a one-to-one correlation with its underlying patent. However, other types of pricing methods may be provided that have other means of determining the pricing. For example, a group or category pricing method may be provided.

In an alternate embodiment, the pricing of the contracts may be based on a separate base market with regard to related groupings of patents or other technology. For example, the other base market may be a bond market. In an embodiment, individual bonds may be established and traded based on a particular patent and its royalty revenue. Where there are established patents or patent portfolios with established royalty streams that may be estimated in the future with low levels of risk, those underlying patents could have bonds traded that are tied to the royalty streams. For example, there are many examples of patent pools in well-known technologies such as MPEG (e.g., MPEG LA), for which ongoing and well established royalty streams are predictable. For such patents or portfolios bonds may be established and traded. Once a bond market is established for a multitude of patents, these patents/bonds can be classified or grouped with regard to their category and valuation. For example, certain technology areas can be grouped together. Patents may also be grouped based on strength, the scope of the claim coverage or other factors. As the bonds are traded, the trading prices for the bonds can be used to help to establish pricing (e.g., an underlying royalty rate) for patent license contracts in related categories. Thus, even though a newly issued patent may not have the predictable royalty revenue of the patents underlying the bond market for the patents; where the newly issued patent is in a similar category by technology and has a similar valuation based on the strength of the patent and the scope coverage of the claims as an underlying patent that has patent or groups of patents in a bond patent category—the same data can be used to establish the royalty rate that should be set for the newly issued patent e.g., the price of the patent license contract.

In an example where MPEG technology is categorized in a certain area and a patent valuation system is established where a patent is valued from 1 to 100 (where 1 is a weak patent and 100 is a very strong patent); MPEG LA patents (for which bonds have been established) may be determined to have a valuation of between 80 and 100. A newly issued patent covering MPEG technology may be evaluated by the exchange committee. If it is determined that the new MPEG patent is valid and enforceable and its valuation based on certain well known analysis techniques, as discussed above, is between 80 to 100 for that patent; the pricing (e.g., the royalty rate for the underlying patent license) can be set based on the MPEG LA bonds. Well known principles for setting of rates (e.g., mortgages) based on bond trading prices can be used to establish the rates for the patent contracts. Thus, the present invention provides a two-tier system where the patent contracts are priced and based on the active patent bond trading market in place. In an alternate embodiment, a three-tiered system may be provided where there is also an options market which is based on the patent contracts. Such a patent options market which would allow for parties to hedge their positions in either the patent bonds or the patent license futures contracts.

While particular embodiments have been shown and described, it will be apparent to those skilled in the art that changes and modifications may be made without departing from the principles of the patent licensing market, exchange or patent license contracts in their broader aspects. The matter is set forth in the foregoing description and accompanying drawings is offered by way of illustration only and not as a limitation.

What is claimed is:

1. A license market comprising:
an exchange platform where license contracts may be traded, the platform including:
a system for posting license contract prices, license contract terms and a correlation feature for correlating the contract price to a license rate;
a purchasing feature for providing the purchase of the license contracts;
a selling feature for providing the selling of the license contracts; and
a clearing feature to provide for the execution of the license contracts.

2. The license market of claim 1 wherein the license rate is a royalty rate.

3. The license market of claim 1 wherein the license rate is a total rate for a paid-up license under the license contract.

4. The license market of claim 1 wherein the license rate is a per unit rate under the license contract.

5. The license market of claim 1 wherein the exchange platform allows for companies who wish to obtain licenses and speculators to electronically enter bids using the exchange platform.

6. The license market of claim 1 wherein the clearing feature insures that parties who have acquired license contracts will execute the contracts and the underlying license agreements according to the terms of the license contracts.

7. The license market of claim 1 wherein the exchange platform provides for license auctions and further includes a liquidity feature for assuring sufficient liquidity so that buyers and sellers will be present during the auction process.

8. The license market of claim 7 wherein the liquidity feature comprises at least a market maker, a scarcity feature to control the number of contracts available or a controlled auction period for maximizing the number of transactions that may occur during each auction.

9. The license market of claim 1 wherein the license contract pertains to intellectual property including a patent.

10. A license contract for trading in a marketplace comprising:
contract terms including a price that correlates to a royalty rate;
preset license terms including the royalty basis, up front payments, exclusivity terms and a term of the contract.

11. The license contract of claim 10 wherein the contract is traded in an exchange in order to set a market price for the price of the contract.

12. The license contract of claim 10 further comprising a futures contract for purchasing the right to obtain a license at a future date.

13. The license contract of claim 10 wherein the price of the license contract may fluctuate based on the trading of the license contract.

14. A method of trading a license contract comprising the steps of:
providing an exchange platform for entering offers to buy and sell license contracts;
entering an offer to sell the license contract at a price that correlates to a royalty rate;
entering an offer to purchase the license at the price; and
executing the license contract and obtaining a license at the royalty rate.

15. The trading method of claim 14 wherein the license contract pertains to intellectual property including a patent and the contract includes non-variable license terms including the royalty basis, up front payments, exclusivity terms and a term of the contract.

16. The trading method of claim 14 wherein the exchange platform provides for electronic trading by buyers and sellers using a transparent process so that all trades are posted in real time and providing a uniform price auction.

17. The trading method of claim 14 wherein the license contract, relating to intellectual property and further comprising the step of posting the license contract on the exchange platform, prior to using the underlying intellectual property in litigation so that allegedly infringing parties may obtain licenses at rates set by the exchange.

18. The trading method of claim 14 wherein a computer readable medium is provided for establishing a purchasing feature, a selling feature and a clearing feature for handing the offer to purchase, the offer to sell and execution of the contract, respectively.

19. The trading method of claim 14 further comprising the step of paying the license contract owner a premium upon purchase of each contract.

20. The trading method of claim 14 wherein the exchange platform provides for a single auction on each individual license contract and the method further comprising the step of limiting the number of licenses to be granted for the underlying intellectual property and including in the contract terms an explicit identification of the maximum number of licenses to be granted in a specific field of use in order to insure for purchasers of the license contracts that the price being bid cannot be undercut by parties in another auction separate the single auction.
